(19) United States
(12) Patent Application Publication
(10) Pub. No.: US 2005/0055231 A1
(43) Pub. Date: Mar. 10, 2005

(54) Candidate-initiated background check and verification

(76) Inventor: Geoffrey C. Lee, Santa Ana, CA (US)

Correspondence Address: MAINE & ASMUS, 100 MAIN STREET, P O BOX 3445, NASHUA, NH, 03061-3445, US

(21) Appl. No.: 10/771,534

(22) Filed: Feb. 4, 2004

Related U.S. Application Data
(60) Provisional application No. 60/501,210, filed on Sep. 8, 2003.

(51) Int. Cl. G06F 17/60

(52) U.S. Cl. 705/1; 705/8

(57) ABSTRACT

Disclosed techniques allow candidates to initiate their own background checks (e.g., identity verification, criminal history) in advance so that employers, recruiters, consumers, or other seeking parties can have all information needed to consider the candidate for engagement. The candidate's pre-screened status is indicated with a seal or identifying mark associated with the candidate's resume, application, service file, or advertising, thereby allowing reviewing parties to identify pre-screened candidates for primary consideration. Information from the background check is compiled into a report that can be accessed online or in hardcopy. The candidate can annotate the report prior to its release to other parties. The report can be associated with an expiration date to prevent engagements based on stale information. A local database containing the various candidates' information can be stocked by Internet data crawler applications that search targeted remote databases. The local database is maintained current, and can be rapidly searched.

### RELATED APPLICATIONS

This application claims the benefit of U.S. Provisional Application No. 60/501,210, filed Sep. 8, 2003, which is herein incorporated in its entirety by reference.

### FIELD OF THE INVENTION

The invention relates to background checks and verification, and more particularly, to techniques that enable a person to verify their own background thereby allowing a potential employer or other interested parties the ability to seek only qualified pre-screened candidates.

### BACKGROUND OF THE INVENTION

There are a number of situations, where people interact with one another, and one of the interacting parties must make a decision as to whether or not to partner with or otherwise “engage” another party. For example, employers interact with job seekers to make hiring decisions, persons looking for dates interact with potential suitors to make dating decisions, and consumers looking for service providers interact with potential providers (plumbers, attorneys, carpenters) to make retainer decisions. In all such cases, the controlling party needs information about the candidate to make a proper engagement decision.

Typically, most relevant information about a particular party is learned through face-to-face interaction or indirect communication (e.g., video dating service or submission of resumes through on-line job boards). Other important information, however, such as criminal background, financial instability, and invalidity of certain representations (e.g., level of schooling, licensing, work experience) is generally not readily communicated by the applicant. As such, the party seeking to engage assumes a risk that their target applicant is upstanding, reliable, and otherwise a stable and viable candidate. To minimize this risk, the party can have a background check performed on a prospective candidate to determine the existence of negative information.

However, parties such as employers historically have been much more likely to verify a job candidate's background only after they have decided to choose and move forward with a particular candidate for a position. Many smaller companies did not have the resources or the money to place every employee through a background screening process. Further complicating the situation is that background checks are regulated under the United States Government within the Fair Credit Reporting Act. More recently, background checks are being conducted more efficiently through the use of computerized search technology, online databases, and the Internet.

For example, there are a number websites, such as www.hirecheck.com, www.screennow.com, and www.hireright.com, which are online databases for retrieving backgrounds potential employees. These online systems employ varying algorithms that may search one or more databases for a match from the entered data. There are also commercial databases such as www.krollworldwide.com, www.in-foquest.com, and www.adp.com that are fee based online services that can also be used to conduct background checks on individuals. These systems generally search credit bureaus, online criminal databases to generate a report for the requesting corporation. The criterion varies depending upon the databases and the offline searches done to compose the background check.

With most conventional background check services, particularly those used in the hiring process, the employer typically receives negative information about a candidate only after conducting the expensive and time consuming interview process. Moreover, there may be a reasonable explanation as to why the negative information exists, thereby exonerating the candidate and allowing their status as a viable candidate to remain in tact. For example, an applicant may have attended a college that has lost his records, and is therefore erroneously indicating that he did not attend the school. However, due to the delicate nature of this type of situation, such an exonerating explanation would not come to light using conventional background check techniques, and the candidate would likely be rejected.

Other problems remain as well. For instance, despite all the advances associated with online information, the various public and private databases do not necessarily collaborate with each other. Thus, conventional systems are not instantaneous, in that multiple databases must be searched. In addition, the engaging party typically bears the cost for the screening process, putting an inordinate expense on that party, rather than distributing fair shares of that expense among each of the candidates. This expense to the engaging party is increased when a second background check is performed to prevent engaging on stale data.

Therefore, what is needed are techniques that allow applicants or other candidates to obtain background checks in advance so that the likes of employers, consumers, or other such parties can have all information needed to consider the candidate for engagement. The advance background check should provide reliable information about the candidate, and allow the candidate to annotate information included in the background report.

### BRIEF SUMMARY OF THE INVENTION

One embodiment of the present invention provides a system for performing a candidate-initiated background check and verification. The system includes a search module adapted to issue a candidate-initiated query to one or more databases storing information associated with various potential candidates, so as to assess the candidate's acceptability for a particular engagement based on at least one of a background check and verification of information provided by the candidate. A report generation module is configured to generate a report that includes query results provided by the search module, the results indicating the candidate's acceptability for the particular engagement, wherein the report can be selectively viewed by a potential engaging party and further includes at least one section where the candidate can annotate the results. The report can be associated with an expiration date, to prevent engagement based on stale or otherwise incorrect information.

In one such embodiment, the candidate is a job seeker, the potential engaging party is a potential employer having a pre-defined set of criteria for persons the employer is willing to hire, and the particular engagement is employment with the employer. Alternatively, the candidate is a date seeker that is using a dating service, the potential engaging party is a person having a pre-defined set of criteria for date seekers that person is willing to date, and the particular engagement is a date with that person. The candidate-initiated background check and verification can be performed online, where the candidate can accesses the system via the Internet or other network to initiate the issuing of the query. The candidate-initiated background check and verification can be performed, for example, in the context of an online job search service or an online dating service.

In another such embodiment, the report generation module is further configured to assign the candidate a unique identification number and seal that are associated with the candidate. The seal indicates that the report is available, and the unique identification number allows the potential engaging party to access the report (e.g., via a secure Internet link). The system may further include the one or more databases storing information associated with various potential candidates. In one such case, the one or more databases are local to the system, thereby enabling rapid query-based searching. The one or more local databases can be stocked at least in part by data crawler applications that search targeted remote databases. In another such case, the one or more databases are remote to the system.

The search module may include, for example, at least one of an address history search module for searching for the candidate's address history, a civil record search module for searching for civil action records associated with the candidate, a criminal record search module for searching for criminal records associated with the candidate, and a social security verification module for verifying the candidate's social security number. Here, the search module may further include one or more display modules, each configured to enable display of at least a portion of the results included in the report. The system may further include a candidate data intake module that is programmed or otherwise configured to prompt the candidate to provide personal information needed to execute the query. The personal information includes at least one of the candidate's name, social security number, date of birth, and current address.

Another embodiment of the present invention provides a system for performing a candidate-initiated background check and verification. This particular system includes a local database stocked with information relevant to various potential candidates, wherein the information enables at least one of background checks and verification to be performed so as to pre-screen a candidate's acceptability for a particular engagement. One or more search modules are communicatively coupled with the database. Each search module is configured to issue a candidate-initiated query to the database to assess the candidate's acceptability for the particular engagement. A report generation module is configured to generate a report that includes query results provided by the one or more search modules. The results indicate the candidate's acceptability for the particular engagement, and the report is associated with a unique identification number that allows the potential engaging party to access the report.

In one such embodiment, the report generation module is further configured to associate the report with a seal that is placed on at least one of the candidate's resume, application, online dating service file, or advertising. The seal indicates to the potential engaging party that the report is available. The report can be associated with an expiration date.

Another embodiment of the present invention provides a method for performing a candidate-initiated background check and verification. The method includes issuing a candidate-initiated query to one or more databases storing information associated with various potential candidates, so as to assess the candidate's acceptability for a particular engagement based on at least one of a background check and verification of information provided by the candidate. The method further includes generating a report that includes results of the candidate-initiated query, where the results indicate the candidate's acceptability for the particular engagement. The method further includes allowing the candidate to review and annotate the report prior to any selective viewing by a potential engaging party.

In one such embodiment, the candidate-initiated background check and verification is performed online, and issuing the candidate-initiated query is triggered in response to the candidate providing input via the Internet. The candidate-initiated background check and verification can be performed, for example, in the context of an online job search service or an online dating service. Alternatively, the candidate-initiated background check and verification can be performed on-site using a kiosk (e.g., at a job fair or dating service location).

The method may further include storing the information associated with various potential candidates in one or more local databases, thereby enabling rapid query-based searching. In such a case, the method may further include stocking the one or more local databases at least in part using data crawler applications that search targeted remote databases. In an alternative embodiment, issuing the candidate-initiated query to one or more databases includes accessing one or more remote databases. The method may further include prompting the candidate to provide personal information needed to execute the query. The personal information includes, for example, at least one of the candidate's name, social security number, date of birth, and current address.

Issuing the candidate-initiated query to one or more databases may further include at least one of: searching for the candidate's address history, searching for civil action records associated with the candidate, searching for criminal records associated with the candidate, and verifying the candidate's social security number. The method may further include assigning the candidate a unique identification number that allows the potential engaging party to access the report. The method may further include associating the report with an expiration date. The method may further include associating the report with a seal (or other identifying marker) that is placed on at least one of the candidate's resume, application, online dating service file, or advertising. The seal indicates to the potential engaging party that the report is available.

The method may further include allowing the potential engaging party to review the report in response to the candidate releasing the report for review. The method may further include allowing the potential engaging party to sanction additional reports relevant to the candidate in response to the candidate's approval. The method may further include notifying the candidate that the report has expired if an expiration date associated with report has passed. Here, the method may further include recertifying the report (e.g., re-checking candidate's background and re-verifying candidate information) in response to the candidate affirmatively responding to the notifying. The method may further include periodically recertifying the report to prevent engagement based on stale data. The method may further include allowing the potential engaging party to recertify the report in response to approval by the candidate.

Note that embodiments of the present invention can be implemented, for example, as a computer readable medium encoded with software, that when executed by a processor, causes the processor to carry out the method for performing a candidate-initiated background check and verification.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of a background verification system that enables self-screening for various types of applicants configured in accordance with one embodiment of the present invention.

FIG. 2 illustrates a method for use by an applicant that wishes to have their own background verified to distinguish themselves from other non-pre-screened applicants in accordance with one embodiment of the present invention.

FIGS. 3a and 3b illustrate a method for use in conjunction with an online job search service that allows a job seeker to pre-screen their own background to distinguish themselves from other non-pre-screened job seekers in accordance with one embodiment of the present invention.

FIG. 4a is a graphical user interface for initiating job seeker verification in accordance with one embodiment of the present invention.

FIG. 4b is a graphical user interface displaying results to an employer's query to a database of job seekers, some of whom are pre-screened in accordance with one embodiment of the present invention.

FIG. 4c illustrates a graphical user interface for showing a summary of a verification report, as well as underlying functionality that interface, in accordance with one embodiment of the present invention.

FIG. 4d illustrates a graphical user interface for showing a full verification report, as well as underlying functionality that interface, in accordance with one embodiment of the present invention.

### DETAILED DESCRIPTION OF THE INVENTION

Embodiments of the present invention provide techniques that allow applicants or other candidates to obtain background checks in advance so that the likes of employers, recruiters, consumers, or other seeking parties can have all information needed to consider the candidate for engagement. The candidate's pre-screened status can be indicated with an official seal or identifying mark displayed or otherwise associated with the candidate's resume, application, or advertising, thereby allowing reviewing parties to identify pre-screened candidates for primary consideration over other non-pre-screened candidates.

The background check can include, for example, identity verification, criminal history, civil judgment history, drug screening, education verification, and/or any other information that can be legally obtained and used in the evaluation of a candidate for a particular position (e.g., employee, suitor, service provider). The resulting information is compiled into a report that can be electronically accessed or provided in hardcopy. If desired, the candidate can annotate information included in the background report prior to the report being released to other parties, so that information that might otherwise damage the candidate's chances of being engaged can be remedied or at least commented on when appropriate.

In addition, the seeking party (e.g., employer, recruiter, consumer, person looking for a date) is spared the cumulative cost of having to screen all candidates, as each of the individual candidates bears the cost of his own background check. At the same time, the candidate is afforded the benefit of distinguishing himself from other non-pre-screened candidates. Also, the pre-screened results of each candidate can be associated with an expiration date to prevent engagements based on information that may no longer be accurate. As such, if the seeking party encounters an expired or otherwise aged report, a message can be sent to the candidate requesting an updated background search. The candidate's pre-screened status can therefore be periodically updated.

A database containing the desired information can be maintained locally, and stocked by Internet data crawler applications that search targeted remote databases on a pre-established schedule. The local database can also be stocked with information that is input via data entry (e.g., input by a human or by a scanner configured with optical character recognition). The local database is therefore maintained current, and can be rapidly searched for relevant information. Each database query can be based on user input, such as a candidate's first, middle, and last name, social security number, date of birth, and current address including city and state.

Verification System Architecture

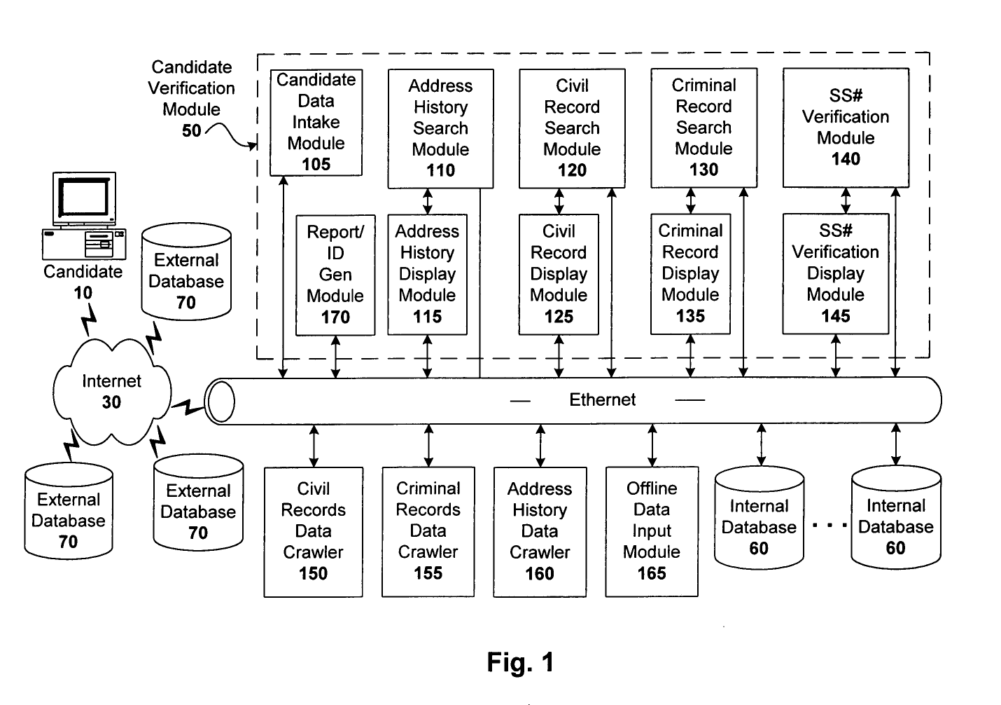

FIG. 1 is a block diagram of a background verification system that enables self-screening for various types of applicants configured in accordance with one embodiment of the present invention.

The applicant can log into the system via device 10. The device 10 can be any form of computer such as a personal computer, laptop, personal digital assistant, or tablet that is connected to the Internet. The connection to the Internet 30 can be conventionally implemented with wire connections via the likes of telephone or cable wiring and an appropriate modem, or with various conventional wireless interfaces. Alternatively, the applicant can call in to customer service (not shown) to have a background verification performed. Alternatively, the applicant can access the system “on-site” at, for example, a career fair or dating service location. In such an embodiment, the system could be contained in a user-friendly kiosk.

The applicant may be, for example, a job seeker or a person looking for a date via a dating service. Alternatively, the applicant may be a service provider (e.g., plumber, carpenter, mechanic, lawyer) wishing to attract customers that will engage the applicant. Alternatively, the applicant may be a small business that wishes to establish credibility and good standing in its business community, but has not yet been in existence long enough to receive a favorable status given by traditional reporting agencies (e.g., Dun and Bradstreet).

As can be seen, the system includes a candidate verification module 50 that is communicatively coupled with a local database 60, an offline data input module 165, an address history data crawler 160, a criminal records data crawler 155, and a civil records data crawler 150. Any conventional networking techniques can be used here, with this particular example using an Ethernet architecture. The Ethernet or other local area network is communicatively coupled to the Internet 30, to which a number of remote databases 70 are connected. An applicant can access the system via the Internet 30 to commission a pre-screen background check. The results of the check are then presented to the applicant in a report.

In this particular embodiment, the candidate verification module 50 is configured to perform a pre-screen background check that includes an address history search, a civil record search, a criminal search, and a social security number verification. In more detail, the module 50 includes a candidate data intake module 105, an address history search module 110 and corresponding display module 115, a civil record search module 120 and corresponding display module 125, a criminal record search module 130 and corresponding display module 135, and a social security number (SS#) verification module 140 and corresponding display module 145.

Each functional module can be coded using conventional programming techniques, such as Extensible Markup Language (XML) and other suitable mark-up languages for creating Web documents for an Internet-based system. Alternatively, programming languages such as C or visual Basic could be employed to implement the functionality and interfaces of the system. In one particular embodiment, the system employs XML to retrieve information matching the candidate's input, and to return output that is posted to a report within that candidate's online profile. In addition, the system uses ColdFusion Markup Language (CFML) to execute the XML gateways with existing databases and parse the output accordingly. The data elements that are queried via XML in this example include: address history, civil records (e.g., bankruptcy, tax liens, civil judgments), criminal records, and social security number. The sub-modules of module 50 will now be discussed in detail.

Candidate Data Intake Module

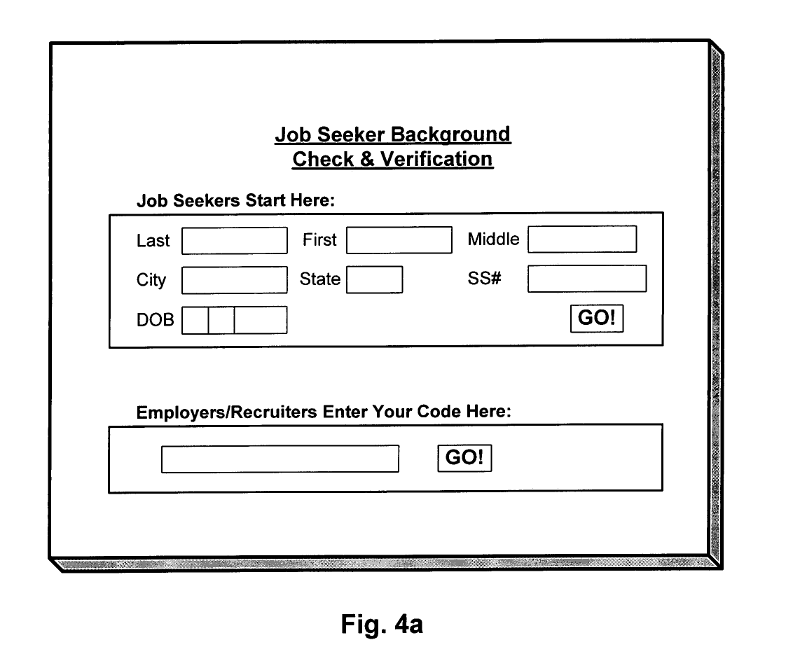

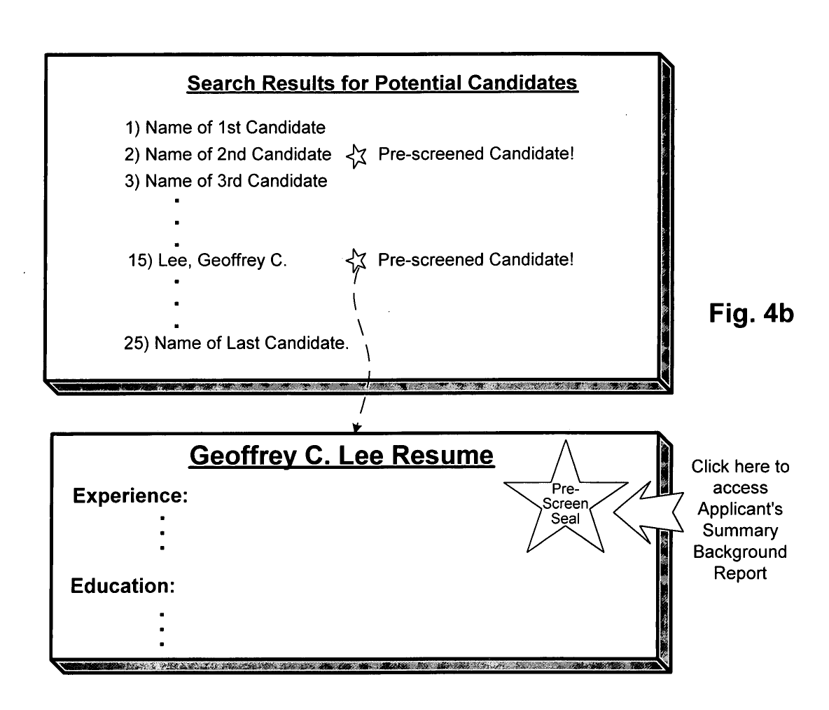

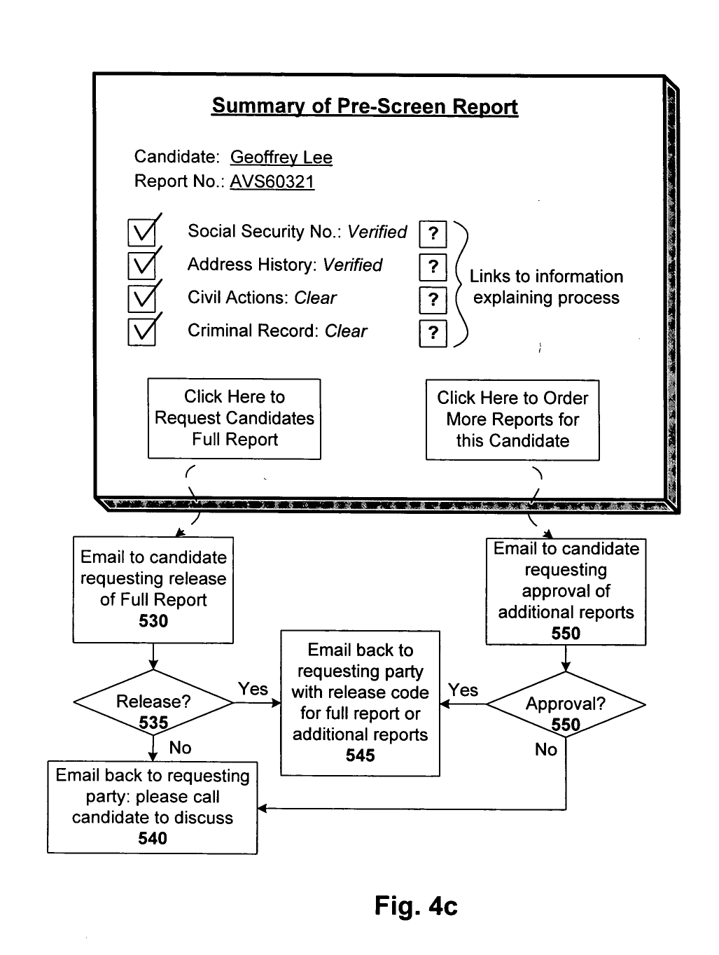

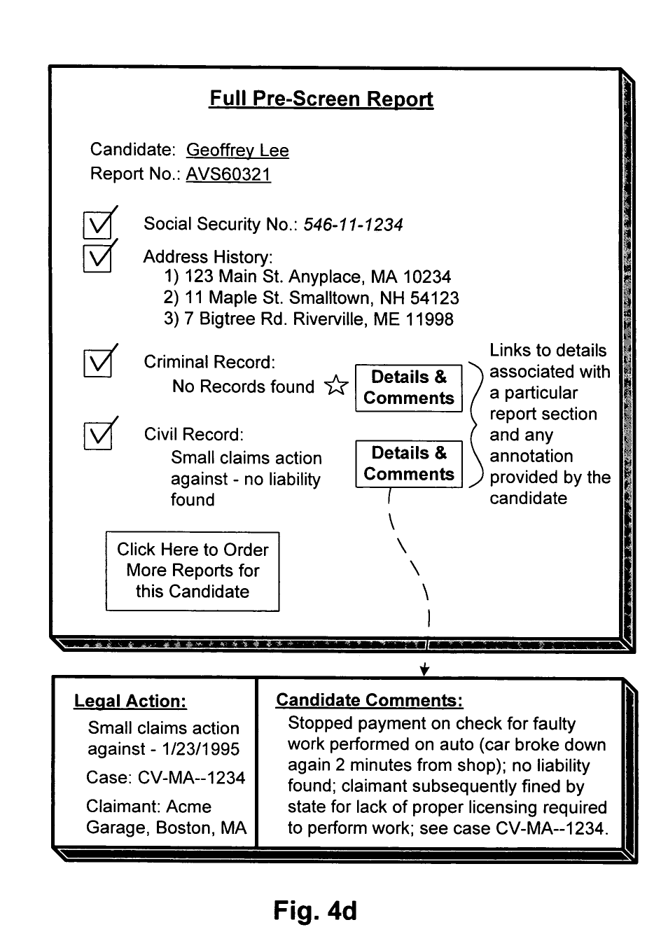

The candidate data intake module 105 is configured to prompt the candidate to provide information needed to carry out the verification process. In one embodiment, the candidate is prompted to enter the following data: first, middle, and last name, social security number, date of birth, and current address including city and state. A screen shot of this data intake page is shown in FIG. 4a. Each of the various search and verification modules then execute a query of the local database 60 using the input received from the applicant.

Address History Search Module

The address history search module 110 is configured to search for the applicant's previous addresses. In one specific embodiment, module 110 is implemented as a Cold Fusion query to an address history section of the local database 60 designed to use the applicant's social security number and name in order to produce a history of all associated addresses. Example code is shown here:

<cftry>

<cfhttp

url=“http://locateplus.com:8001/sw/personSearchSw.asp?userID=chTest&tuLastName=#U
RLEncodedFormat(trim(getJobseeker.Jbs_LName))#&tuFirstName=#URLEncodedFormat
(trim(getJobseeker.Jbs_FName))#&tuMiddleName=#URLEncodedFormat(trim(getJobsee
ker.Jbs_MName))#&tuCity=#URLEncodedFormat(trim(getJobseeker.Jbs_City))#&tuState
=#URLEncodedFormat(trim(getJobseeker.State_Abbr))#&tuSSN=#URLEncodedFormat(t
rim(getJobseeker.Jbs_SSN))#&wildcards=100010100100001” method=“GET”
resolveurl=“false”></cfhttp>

<CF_XMLParser XML=“#cfhttp.fileContent#” output=“parse”>
<cftry>
<cfset root=“parse.persons”>
<cfset ListPersons = “#root#.CHILD_LIST”>
<cfset ListPersons = Evaluate(ListPersons)>
<cfset tagFlag = “person”>
<cfloop index=“index3” list=“#ListPersons#”>

<cfif Left(index3, Len(tagFlag)) is not tagFlag>

<cfset ListPersons = ListDeleteAt(ListPersons,1)>

</cfif>

</cfloop>
<cfset useThisOID = “”>
<cfloop index=“index3” list=“#ListPersons#”>

<cfset getOID = “#root#.#index3#.ID”>
<cfset getOID = Evaluate(getOID)>
<cfif useThisOID is “”>

<cfset getOID = getOID>

</cfif>
<cfset getfName = “#root#.#index3#.first.INNER_TEXT”>
<cfset getfName = Evaluate(getfName)>
<cfset getlName = “#root#.#index3#.last.INNER_TEXT”>
<cfset getlName = Evaluate(getlName)>
<cfif isNumeric(getOID) and ( trim(getfName) is

trim(getJobseeker.Jbs_FName) or trim(getlName) is trim(getJobseeker.Jbs_LName) ) >

<cfset useThisOID = getOID>

</cfif>

</cfloop>
<cfhttp

url=“http://www.locateplus.com:8001/sw/personReportSW.asp?userID=chTest&o;=#useTh
isOID#” method=“GET” resolveurl=“false”></cfhttp>

<CF_XMLParser XML=“#cfhttp.fileContent#” output=“parse”>
<cfcatch></cfcatch>
</cftry>
<cfquery datasource=“#application.DSN#” name=“saveReport”>
update JobSeekerReports
set Jsr_Report = ‘#cfhttp.fileContent#’
where Jsr_ID = #curJsrID#
</cfquery>
<cfcatch>

<cfset reportOK=0>

</cfcatch>

</cftry>

Address History Display Module

The address history display module 115 enables the system to properly parse the output format of the address history query, and to display the applicant's address history. Example Cold Fusion code is shown here:

<cfif not isDefined(“URL.RID”)>

<cflocationURL=“main.cfm?go=Message&msg=InvalidParam”
addtoken=“NO”>

</cfif>
<cfif not isNumeric(URL.RID)>

<cflocationURL=“main.cfm?go=Message&msg=InvalidParam”
addtoken=“NO”>

</cfif>
<span class=“BodyText”>
<cfquery datasource=“#application.DSN#” name=“getJbs”>
select State_Name, Jbs_FName, Jbs_MName, Jbs_LName,
Jbs_jsvid,
Jbs_Report1Comment, jbs_expirationdate
from States, Jobseekers
where Jobseekers.State_ID = States.State_ID and

Jbs_ID = #session.LoggedIn#

</cfquery>
<span class=“BodyText_BoldBigOrange”>
<cfoutput>
Address History for: #getJbs.Jbs_FName# #getJbs.Jbs_MName#
#getJbs.Jbs_LName#<br>
JSV Code: #getJbs.jbs_jsvid#
</cfoutput>
</span>
<br>
<br>
<cfquery datasource=“#application.DSN#” name=“chkReportID”>
select Jsr_ID, Jsr_Report
from JobseekerReports
where Jsr_ID = #URL.RID# and

Jbs_ID = #session.LoggedIn#

</cfquery>

The following are addresses associated with this candidate from third party sources. They may not reflect the most recent address but are a valuable resource to compare the “residential history” most employers ask for during the application process. Also, additional jurisdictional searches for both civil and criminal records can be sanctioned based on other addresses indicated in the history.

<br>
<br>
<br>
<cfif chkReportID.recordcount eq 0>

<cflocationURL=“main.cfm?go=Message&msg=InvalidParam”
addtoken=“NO”>

</cfif>
<cfif DateCompare(now( ), getJbs.jbs_expirationdate) lte 0>
<cftry>

<CF_XMLParser XML=“#chkReportID.Jsr_Report#”
output=“parse”>
<cfset root=“parse.personreport”>

<cfcatch type=“Any”>
</cfcatch>
</cftry>
<cfif not isDefined(“root”)>

<cflocation URL=“main.cfm?go=Message&msg=ErrorParsing”
addtoken=“NO”>

</cfif>
<!---

Report Fields:
Field display, show/hide type, etc.
Show hide type:
0=hide field and data (skip field)
1=show field and data
2=hide field and show data
c=put comma after data

pick one format:

a = as is
d = format data as date
i = image
--->
<cfscript>
function XMLData(record, field, format)
{

returnStr =“”;
getField = “#root#.#record#.#field#”;
if(format is “d”)
{

tempField = “#getField#.month.INNER_TEXT”;
tempField = “#Evaluate(tempField)#”;
returnStr = “#tempField#”;
tempField = “#getField#.year.INNER_TEXT”;
tempField = “#Evaluate(tempField)#”;
returnStr = “#returnStr#/#tempField#”;

}
else
{

getField = “#getField#.INNER_TEXT”;
getField = “#Evaluate(getField)#”;
returnStr = “#getField#”;

}
return returnStr;

}
</cfscript>
<cftry>

<cfset ListParts = “#root#.CHILD_LIST”>
<cfset ListParts = Evaluate(ListParts)>
<cfcatch></cfcatch>

</cftry>
<cfloop index=“index” list=“#ListParts#”>

<cfif index is “personal”>

<!--- Report for:
<cftry>

<cfset tempValue=“”>
<cfset tempValue = XMLData(index, “first”, “a”)>
<cfoutput>#tempValue# </cfoutput>
<cfcatch></cfcatch>

</cftry>
<cftry>

<cfset tempValue=“”>
<cfset tempValue = XMLData(index, “middle”, “a”)>
<cfoutput>#tempValue# </cfoutput>
<cfcatch></cfcatch>

</cftry>
<cftry>

<cfset tempValue=“”>
<cfset tempValue = XMLData(index, “last”, “a”)>
<cfoutput>#tempValue# </cfoutput>
<cfcatch></cfcatch>

</cftry>
<br> --->

<!--- Parsing addresses --->
<cfelseif index is “addresses”>

<cftry>

<cfset ListAddresses = “#root#.#index#.CHILD_LIST”>
<cfset ListAddresses = Evaluate(ListAddresses)>
<cfif ListLen(ListAddresses) gt 0>

Addresses:<br><br>

</cfif>
<cfcatch></cfcatch>

</cftry>
<cfloop index=“index2” list=“#ListAddresses#”>

<cftry>

<cfset tempValue=“”>
<cfset tempValue = XMLData(index,
“#index2#.addressA”, “a”)>
<cfif trim(tempValue) is not “”>

<cfoutput>#tempValue#<br></cfoutput>

</cfif>
<cfcatch></cfcatch>

</cftry>
<cftry>

<cfset tempValue=“”>
<cfset tempValue = XMLData(index,
“#index2#.addressB”, “a”)>
<cfif trim(tempValue) is not “”>

<cfoutput>#tempValue#<br></cfoutput>

</cfif>
<cfcatch></cfcatch>

</cftry>
<br>

</cfloop>

</cfif>

</cfloop>
<cfset reportType = 1>
<cfset strComment = getJbs.Jbs_Report1Comment>
<cfinclude template=“Dsp_CommentForm.cfm”>
</span>
<cfelse>

This report has expired.

</cfif>

Civil Record Search Module

The civil record search module 120 is configured to search civil records associated with the applicant. In one specific embodiment, module 120 executes an XML query into a civil actions section of the local database 60. This database section may include, for example, bankruptcy, tax lien, and other civil judgment records. Here, the query includes the candidate's name and is limited to the specific state that was input by the user as their current state of residence. However, other embodiments may include a multi-jurisdictional search. In such a case, the query may also include other states indicated by the address history search. Example Cold Fusion code is shown here:

<cfset curJsrID = getID.curID>
<cfquery name=“getJobseeker” datasource=“#application.DSN#”>
select jbs_id,Jbs_SSN
from jobseekers
where jbs_id=#session.LoggedIn#
</cfquery>
<cftry>

<cfhttp

url=“http://locateplus.com:8001/sw/laSearchSw.asp?hogLastName=#URLEncodedFormat(
trim(getJobseeker.Jbs_LName))#&hogFirstName=#URLEncodedFormat(trim(getJobseeke
r.Jbs_FName))#&hogMiddleName=#URLEncodedFormat(trim(getJobseeker.Jbs_MName
))#&State=#URLEncodedFormat(trim(getJobseeker.State_Abbr))#&wildcards=100100100
100” method=“GET” resolveurl=“false”></cfhttp>

<cfquery datasource=“#application.DSN#” name=“saveReport”>
update JobSeekerReports
set Jsr_Report = ‘#cfhttp.fileContent#’
where Jsr_ID = #curJsrID#
</cfquery>
<cfcatch>

<cfset reportOK=0>

</cfcatch>

</cftry>

Civil Record Display Module

The civil record display module 125 enables the system to properly parse the output format of the civil record search query, and to display the applicant's civil records (if any). Example Cold Fusion code is shown here:

<cfif not isDefined(“URL.RID”)>

<cflocation URL=“main.cfm?go=Message&msg=InvalidParam”
addtoken=“NO”>

</cfif>
<cfif not isNumeric(URL.RID)>

<cflocation URL=“main.cfm?go=Message&msg=InvalidParam”
addtoken=“NO”>

</cfif>
<SCRIPT LANGUAGE=“JavaScript”>
function popUp(url, winname, features) {
sealWin=window.open(url,winname,features);
self.name = “mainWin”;
}
</SCRIPT>
<span class=“BodyText”>
<cfquery datasource=“#application.DSN#” name=“getJbs“>
select State_Name, Jbs_FName, Jbs_MName, Jbs_LName,
Jbs_jsvid,
Jbs_Report2Comment, jbs_expirationdate
from States, Jobseekers
where Jobseekers.State_ID = States.State_ID and

Jbs_ID = #session.LoggedIn#

</cfquery>
<span class=“BodyText_BoldBigOrange”>
<cfoutput>
Civil Records for: #getJbs.Jbs_FName# #getJbs.Jbs_MName#
#getJbs.Jbs LName#<br>
JSV Code: #getJbs.jbs_jsvid#
</cfoutput>
</span>
<br>
<br>
<cfset OKcontinue=1>
<cfquery datasource=“#application.DSN#” name=“chkReportID”>
select Jsr_ID, Jsr_Report
from JobseekerReports
where Jsr_ID = #URL.RID# and

Jbs_ID = #session.LoggedIn#

</cfquery>

If within our database <a href=“coverage.htm” target=“win” onClick=“javascript:popUp(‘coverage.htm’, ‘win’, ‘toolbar=0,location=0,directories=0,status=0,menubar=0,scrollbars=1,resizable=1,width=5 00,height=450′)”>coverage</a>, a statewide search of <cfoutput>#getJbs.State_Name#</cfoutput> was conducted through Bankruptcy, Tax Lien, and Civil Judgments by the candidate's first, last and middle name (if provided). The results are as follows:

<br>
<br>
<cfif chkReportID.recordcount eq 0>

<cflocation URL=“main.cfm?go=Message&msg=InvalidParam”
addtoken=“NO”>

</cfif>
<cfif DateCompare(now( ), getJbs.jbs_expirationdate) lte 0>
<cftry>

<CF_XMLParser XML=“#chkReportID.Jsr_Report#”
output=“parse”>
<cfset root=“parse.filings”>

<cfcatch type=“Any”>

<span class=“BodyText_Bold”>No civil records
found.</span>
<cfset OKcontinue=0>

</cfcatch>
</cftry>
<cfif OKcontinue>

<cfif not isDefined(“root”)>

No civil records found.
<cfset OKcontinue=0>

</cfif>

</cfif>
<cfif OKcontinue>
<!---

Report Fields:
Field display, show/hide type, etc.
Show hide type:
0=hide field and data (skip field)
1=show field and data
2=hide field and show data
c=put comma after data

pick one format:

a = as is
d = format data as date
i = image
--->
<cfscript>
function XMLData(record, field, format)
{

returnStr=“”;
getField = “#root#.#record#.#field#”;
if(format is “d”)
{

tempField = “#getField#.month.INNER_TEXT”;
tempField = “#Evaluate(tempField)#”;
returnStr = “#tempField#”;
tempField = “#getField#.year.INNER_TEXT”;
tempField = “#Evaluate(tempField)#”;
returnStr = “#rerurnStr#/#tempField#”;

}
else
{

getField = “#getField#.INNER_TEXT”;
getField = “#Evaluate(getField)#”;
returnStr = “#getField#”;

}
return returnStr;

}
</cfscript>
<cftry>

<cfset ListFilings = “#root#.CHILD_LIST”>
<cfset ListFilings = Evaluate(ListFilings)>
<cfset tagFlag = “filing”>
<cfloop condition=“ListGetAt(ListFilings,1) is not tagFlag”>

<cfset ListFilings = ListDeleteAt(ListFilings,1)>

</cfloop>
<cfcatch></cfcatch>

</cftry>
<cfloop index=“index” list=“#ListFilings#”>

<cftry>

<cfset tempValue=“”>
<cfset tempValue = XMLData(index, “person.first”, “a”)>
<cfoutput>#tempValue# </cfoutput>
<cfcatch></cfcatch>

</cftry>
<cftry>

<cfset tempValue=“”>
<cfset tempValue = XMLData(index, “person.middle”, “a”)>
<cfoutput>#tempValue# </cfoutput>
<cfcatch></cfcatch>

</cftry>
<cftry>

<cfset tempValue=“”>
<cfset tempValue = XMLData(index, “person.last”, “a”)>
<cfoutput>#tempValue# </cfoutput>
<cfcatch></cfcatch>

</cftry>
<br>
Address:<br>
<cftry>

<cfset tempValue=“”>
<cfset tempValue = XMLData(index, “person.addressA”, “a”)>
<cfoutput>#tempValue# </cfoutput>
<cfcatch></cfcatch>

</cftry>
<br>
<cftry>

<cfset tempValue=“”>
<cfset tempValue = XMLData(index, “person.addressB”, “a”)>
<cfoutput>#tempValue# </cfoutput>
<cfcatch></cfcatch>

</cftry>
<br><br>
<cftry>

<cfset tempValue=“”>
<cfset tempValue = XMLData(index, “stateDesc”, “a”)>
<cfoutput>#tempValue# </cfoutput>
<cfcatch></cfcatch>

</cftry>
<br>
<cftry>

<cfset tempValue=“”>
<cfset tempValue = XMLData(index, “plaintiff”, “a”)>
<cfoutput>#tempValue# </cfoutput>
<cfcatch></cfcatch>

</cftry>
<br>
<cftry>

<cfset tempValue=“”>
<cfset tempValue = XMLData(index, “hfDesc”, “a”)>
<cfoutput>#tempValue# </cfoutput>
<cfcatch></cfcatch>

</cftry>
<br><br><br>

</cfloop>

The results you viewed may include matches that are not necessarily the candidate who has ordered this service. Please review each match closely as some records may contain errors, omissions, or other factors that have resulted in a “possible match.” In an effort to be diligent, we cannot omit a match that our system flagged due to lacking information with a public record source. Thus, you may wish to supplement this search with a manual search of the identified civil records. A supplemental manual search can be ordered at <a href=“http://www.locateplus.com”>www. locateplus.com </a>.

</cfif>
<cfset reportType = 2>
<cfset strComment = getJbs.Jbs_Report2Comment>
<cfinclude template=“Dsp_CommentForm.cfm”>
</span>
<cfelse>

This report has expired.

</cfif>

Criminal Record Search Module

The criminal record search module 130 is configured to search criminal records associated with the applicant. In one specific embodiment, module 130 executes an XML query into a criminal actions section of the local database 60. This database section may include, for example, convictions, acquittals, sex offender records, and other criminal records. The query here includes the candidate's name and is limited to the specific state that was input by the user as their current state of residence. However, and as previously explained, other embodiments may include a multi-jurisdictional search (e.g., based on other states identified in the candidate's address history). In addition, the query may include other information to facilitate the search where allowed (e.g., SS# and DOB). Example Cold Fusion code is shown here:

<cfhttp url=“http://www.verifacts.com/GateWay.cfm?GatewayENTERSECT˜#URLstr#”
method=“GET” resolveurl=“false”></cfhttp>
<!--- <cfoutput>#cfhttp.filecontent#</cfoutput> --->

<cfset XMLData=trim(cfhttp.filecontent)>
<cfset XMLData=Right(XMLData, Len(XMLData)-21)>
<cfset XMLData=Replace(XMLData, “Search-Results”, “SearchResults”, “ALL”)>
<cfquery datasource=“#application.DSN#” name=“saveReport”>
update JobSeekerReports
set Jsr_Report = ‘#XMLData#’
where Jsr_ID = #curJsrID#
</cfquery>
<cfcatch>

<cfset reportOK=0>

</cfcatch>

Criminal Record Display Module

The criminal record display module 135 enables the system to properly parse the output format of the criminal record search query, and to display the applicant's criminal records (if any). Example Cold Fusion code is shown here:

<cfif not isDefined(“URL.RID”)>

<cflocationURL=“main.cfm?go=Message&msg=InvalidParam”
addtoken=“NO”>

</cfif>
<cfif not isNumeric(URL.RID)>

<cflocationURL=“main.cfm?go=Message&msg=InvalidParam”
addtoken=“NO”>

</cfif>
<SCRIPT LANGUAGE=“JavaScript”>
function popUp(url, winname, features) {
sealWin=window.open(url,winname,features);
self.name = “mainWin”;
}
</SCRIPT>
<span class=“BodyText”>
<cfquery datasource=“#application.DSN#” name=“getJbs”>
select State_Name, Jbs_FName, Jbs_MName, Jbs_LName,
Jbs_jsvid,
Jbs_Report3Comment, jbs_expirationdate
from States, Jobseekers
where Jobseekers.State_ID = States.State_ID and

Jbs_ID = #session.LoggedIn#

</cfquery>
<span class=“BodyText_BoldBigOrange”>
<cfoutput>
Criminal Records for: #getJbs.Jbs_FName# #getJbs.Jbs_MName#
#getJbs.Jbs_LName#<br>
JSV Code: #getJbs.jbs_jsvid#
</cfoutput>
</span>
<br>
<br>
<cfset reportOK = 1>
<cfset PIDList=“”>
<cfquery datasource=“#application.DSN#” name=“chkReportID”>
select Jsr_ID, Jsr_Report
from JobseekerReports
where Jsr_ID = #URL.RID# and

Jbs_ID = #session.LoggedIn#

</cfquery>
<cfquery datasource=“#application.DSN#” name=“getState”>
select State_Name
from States, Jobseekers
where Jobseekers.State_ID = States.State_ID and

Jbs_ID = #session.LoggedIn#

</cfquery>

If within our database <a href=“coverage.htm” target=“win” onClick=“javascript:popUp(‘coverage.htm’, ‘win’, ‘toolbar=0,location=0,directories=0,status=0,menubar=0,scrollbars=1,resizable=1,width=5 00,height=450′)”>coverage</a>, a statewide search of <cfoutput>#getJbs.State_Name#</cfoutput> was conducted through our compiled criminal records including incarceration, sex offender, and in some states, local criminal filings. We used the candidate's first, last, middle name, and if the source allowed, date of birth and/or social security number. The results are as follows:

<br>
<br>

<cfif chkReportID.recordcount eq 0>

<cflocation URL=“main.cfm?go=Message&msg=InvalidParam” addtoken=“NO”>

</cfif>
<cfif DateCompare(now( ), getJbs.jbs_expirationdate) lte 0>
<cftry>

<CF_XMLParser XML=“#chkReportID.Jsr_Report#” output=“parse”>
<cfset root=“parse.Search”>

<cfcatch type=“Any”>

<cfset reportOK = 0>

</cfcatch>
</cftry>
<cfif not isDefined(“root”)>

<cfset reportOK = 0>

</cfif>
<cfifreportOK>
<!---
Report Fields:
Field display, show/hide type, etc..
Show hide type:
0 = hide field and data (skip field)
1 = show field and data
2 = hide field and show data
c = put comma after data
pick one format:
a = as is
d = format data as date
i = image
--->
<cfscript>
function XMLData(record, field, format)
{

returnStr=“”;
getField = “#root#.#record#.#field#”;
if(format is “d”)
{

tempField = “#getField#.month.INNER_TEXT”;
tempField = “#Evaluate(tempField)#”;
returnStr = “#tempField#”;
tempField = “#getField#.year.INNER_TEXT”;
tempField = “#Evaluate(tempField)#”;
returnStr = “#returnStr#/#tempField#”;

}
else
{

getField = “#getField#.INNER_TEXT”;
getField = “#Evaluate(getField)#”;
returnStr = “#getField#”;

}
return returnStr;

}
</cfscript>
<cftry>

<cfset getResultsList=“#root#.SearchResults.CHILD_LIST”>
<!--- <cfoutput>#getResultsList#</cfoutput> --->
<cfset getResultsList=“#evaluate(getResultsList)#”>
<!--- <cfoutput>#getResultsList#</cfoutput> --->
<!--- use cfsavecontent to save the result for later since counter comes first --->
<cfsavecontent variable=“pagecontent”>

<table width=“649” cellspacing=“1” cellpadding=“2”

border=“0”>

<tr>

<cfoutput>
<th width=“150”

bgcolor=“#application.TableHeaderBgColor#”
class=“BodyText_BoldWhite”>Database</th>

<th width=“250”

bgcolor=“#application.TableHeaderBgColor#” class=“BodyText_BoldWhite”>Name</th>

<th width=“100”

bgcolor=“#application.TableHeaderBgColor#” class=“BodyText_BoldWhite”>Birth
Date</th>

<th width=“149”

bgcolor=“#application.TableHeaderBgColor#”
class=“BodyText_BoldWhite”>Location</th>

</cfoutput>

</tr>
<cfset

cellbgcolor=“#application.TableRow2BgColor#”>

<cfloop index=“indexResult”

list=“#getResultsList#”>

<cfif cellbgcolor is

“#application.TableRow2BgColor#”>

<cfset

cellbgcolor=“#application.TableRow1BgColor#”>

<cfelse>

<cfset

cellbgcolor=“#application.TableRow2BgColor#”>

</cfif>
<cfset strDB=“”>
<cfset strName=“”>
<cfset strFName=“”>
<cfset strLName=“”>
<cfset strDOB=“”>
<cfset strDOBstr=“”>
<cfset strLoc=“”>
<cfset strRID=“”>
<cfset strDBID=“”>
<cfset getPerson_Name =

“#root#.SearchResults.#indexResult#.FirstName.INNER_TEXT”>

<cftry>

<cfset getPerson_Name =

trim(Evaluate(getPerson_Name))>

<cfset

strName=“#getPerson_Name#”>

<cfset

strFName=“#getPerson_Name#”>

<cfcatch type=“Any”></cfcatch>

</cftry>
<cfset getPerson_Name =

“#root#.SearchResults.#indexResult#.MiddleName.INNER_TEXT”>

<cftry>

<cfset getPerson_Name =

trim(Evaluate(getPerson_Name))>

<cfset strName=“#strName#

#getPerson_Name#”>

<cfcatch type=“Any”></cfcatch>

</cftry>
<cfset getPerson_Name =

“#root#.SearchResults.#indexResult#.LastName.INNER_TEXT”>

<cftry>

<cfset getPerson_Name =

trim(Evaluate(getPerson_Name))>

<cfset strName=“#strName#

#getPerson_Name#”>

<cfset

strLName=“#getPerson_Name#”>

<cfcatch type=“Any”></cfcatch>

</cftry>
<cfset getDBDesc =

“#root#.SearchResults.#indexResult#.DatabaseDesc.INNER_TEXT”>

<cftry>

<cfset getDBDesc =

trim(Evaluate(getDBDesc))>

<cfset strDB=“#getDBDesc#”>
<cfcatch type=“Any”></cfcatch>

</cftry>
<cfset getDOB =

“#root#.SearchResults.#indexResult#.DOB.INNER_TEXT”>

<cftry>

<cfset getDOB =

trim(Evaluate(getDOB))>

<cfset strDOB=“#getDOB#”>
<cfset strDOBstr=“#getDOB#”>
<cfif trim(strDOB) is not “”>

<cfset

strDOB=“#MonthAsString(Mid(strDOB,5,2))# #Mid(strDOB,7,2)#, #Mid(strDOB,1,4)#”>

</cfif>
<cfcatch type=“Any”></cfcatch>

</cftry>
<cfset getLoc =

“#root#.SearchResults.#indexResult#.AddressCity.INNER_TEXT”>

<cftry>

<cfset getLoc =

trim(Evaluate(getLoc))>

<cfset strLoc=“#getLoc#,”>
<cfcatch type=“Any”></cfcatch>

</cftry>
<cfset getLoc =

“#root#.SearchResults.#indexResult#.AddressState.INNER_TEXT”>

<cftry>

<cfset getLoc =

trim(Evaluate(getLoc))>

<cfset strLoc=“#strLoc#, #getLoc#”>
<cfcatch type=“Any”></cfcatch>

</cftry>
<cfset getRID =

“#root#.SearchResults.#indexResult#.RecordID.INNER_TEXT”>

<cftry>

<cfset getRID =

trim(Evaluate(getRID))>

<cfset strRID=“#getRID#”>
<cfif trim(strRID) is not “”>

<cfset PIDList =

ListAppend(PIDList, strRID)>

</cfif>
<cfcatch type=“Any”></cfcatch>

</cftry>
<cfset getDBID =

“#root#.SearchResults.#indexResult#.DatabaseID.INNER_TEXT”>

<cftry>

<cfset getDBID =

trim(Evaluate(getDBID))>

<cfset strDBID=“#getDBID#”>
<cfcatch type=“Any”></cfcatch>

</cftry>
<tr>

<cfoutput>
<td valign=“top”

bgcolor=“#cellbgcolor#” class=“BodyText”>

#strDB#

</td>
<td valign=“top”

bgcolor=“#cellbgcolor#” class=“BodyText”>

#strName#

</td>
<td valign=“top”

bgcolor=“#cellbgcolor#” class=“BodyText”>

#strDOB#

</td>
<td valign=“top”

bgcolor=“#cellbgcolor#” class=“BodyText”>

#strLoc#<!--- #strRID#

#strDBID# --->

</td>
</cfoutput>

</tr>

</cfloop>

</table>

<br>
</cfsavecontent>

<cfcatch type=“Any”></cfcatch>
</cftry>
</cfif>
<cfif ListLen(PIDList) eq 0>

<span class=“BodyText_Bold”>No Records Found for this Subject.</span>

<cfelse>

<cfoutput>#pagecontent#</cfoutput>
<br>
<br>
<br>

The results you viewed may include matches that are not necessarily the candidate who has ordered this service. Please review each match closely as some records may contain errors, omissions, or other factors that have resulted in a “possible match.” In an effort to be diligent, we can not omit a match that our system flagged due to lacking information with a public record source. Thus, you may wish to supplement this search with a manual search of the identified criminal records. A supplemental manual search can be ordered at <a href=“http://www.locateplus.com”>www. locateplus.com.

</cfif> <!--- end of display results --->
<cfset reportType = 3>
<cfset strComment = getJbs.Jbs_Report3Comment>
<cfinclude template=“Dsp_CommentForm.cfm”>
</span>
<cfelse>

This report has expired.

</cfif>

SS# Verification Module

The social security number verification module 140 is configured to verify the social security number of the applicant. In one specific embodiment, module 140 executes an Cold Fusion query into a social security number section of the local database 60. The query here includes the candidate's name, address, and social security number. Example Cold Fusion code is shown here:

<cftry>

<cfhttp

url=“http://locateplus.com:8001/sw/personSearchSw.asp?userID=chTest&first=3&last=5&
tuSsn=#URLEncodedFormat(trim(getJobseeker.Jbs_SSN))#” method=“GET”
resolveurl=“false”></cfhttp>

<cfquery datasource=“#application.DSN#” name=“saveReport”>
update JobSeekerReports
set Jsr_Report = ‘#cfhttp.fileContent#’
where Jsr_ID = #curJsrID#
</cfquery>
<cfcatch>

<cfset reportOK=0>

</cfcatch>

</cftry>

SS# Verification Display Module

The social security number verification display module 145 enables the system to properly parse the output format of the social security verification query, and to display the results (e.g., “verified” or “unable to verify”). Example Cold Fusion code is shown here:

<span class=“BodyText”>
<br>
<cfif not isDefined(“URL.userid”) or not isNumeric(URL.userid)>

<cflocation URL=“employermain.cfm?go=Message&msg=
InvalidParam”

addtoken=“NO”>
</cfif>
<cfquery datasource=“#application.DSN#” name=“getPerson”>
select esp_id, esp_SSN, esp_FName, esp_MName,
esp_LName, esp_City,
States.State_Name
from employersearchpersons, States
where esp_id=#URL.userid# and

employersearchpersons.State_ID = States.State_ID and
emp_id = #session.EmployerLoggedIn#

</cfquery>
<cfif getPerson.recordcount eq 0>

<cflocation URL=“employermain.cfm?go=Message&msg=
InvalidParam”

addtoken=“NO”>
</cfif>
<span class=“BodyText_BoldBigOrange”>
<cfoutput>
SSN Verification for: #getPerson.esp_FName#
#getPerson.esp_MName#
#getPerson.esp_LName#<br>
</cfoutput>
</span>
<br>
<cfquery datasource=“#application.DSN#” name=“chkReportID”>
select esp_ID, esp_ssnReport
from Employersearchpersons
where esp_ID = #URL.userid#
</cfquery>

The social security number provided by the candidate was scanned through third party public sources. A government source may not have been contacted to verify that this number is assigned to, or that the bearer has any employment eligibility to work in the United States. We suggest you contact the appropriate government agency regarding this social security number if you have any questions in that regard.
<br>
<br>

The results are as follows:

<br>
<br>
<br>
<cfif chkReportID.recordcount eq 0>

<cflocation URL=“employermain.cfm?go=
Message&msg=InvalidParam”

addtoken=“NO”>
</cfif>
<cftry>

<CF_XMLParser XML=“#chkReportID.esp_SSNReport#”
output=“parse”>
<cfset root=“parse.persons”>

<cfcatch type=“Any”>

Error

</cfcatch>
</cftry>
<cfif not isDefined(“root”)>

<cflocation URL=“employermain.cfm?go=
Message&msg=ErrorParsing”

addtoken=“NO”>
</cfif>
<!---
Report Fields:
Field display, show/hide type, etc..
Show hide type:
0 = hide field and data (skip field)
1 = show field and data
2 = hide field and show data
c = put comma after data
pick one format:
a = as is
d = format data as date
i = image
--->
<cfscript>
function XMLData(record, field, format)
{

returnStr = “”;
getField = “#root#.#record#.#field#”;
if(format is “d”)
{

tempField = “#getField#.month.INNER_TEXT”;
tempField = “#Evaluate(tempField)#”;
returnStr = “#tempField#”;
tempField = “#getField#.year.INNER_TEXT”;
tempField = “#Evaluate(tempField)#”;
returnStr = “#retumStr#/#tempField#”;

}
else
{

getField = “#getField#.INNER_TEXT”;
getField = “#Evaluate(getField)#”;
returnStr = “#getField#”;

}
return returnStr;

}
</cfscript>
<cftry>

<cfset ListPersons = “#root#.CHILD_LIST”>
<cfset ListPersons = Evaluate(ListPersons)>
<cfset tagFlag = “person”>
<cfloop condition=“ListGetAt(ListPersons,1) is
not tagFlag”>

<cfset ListPersons =
ListDeleteAt(ListPersons,1)>

</cfloop>
<cfcatch></cfcatch>

</cftry>
<cfloop index=“index” list=“#ListPersons#”>

<cftry>

<cfset tempValue=“”>
<cfset tempValue = XMLData(index,
“first”, “a”)>
<cfoutput>#tempValue# </cfoutput>
<cfcatch></cfcatch>

</cftry>
<cftry>

<cfset tempValue=“”>
<cfset tempValue = XMLData(index,
“middle”, “a”)>
<cfoutput>#tempValue# </cfoutput>
<cfcatch></cfcatch>

</cftry>
<cftry>

<cfset tempValue=“”>
<cfset tempValue = XMLData(index,
“last”, “a”)>
<cfoutput>#tempValue# </cfoutput>
<cfcatch></cfcatch>

</cftry>
<br>
Address:<br>
<cftry>

<cfset tempValue=“”>
<cfset tempValue = XMLData(index,
“address.addressA”, “a”)>
<cfoutput>#tempValue# </cfoutput>
<cfcatch></cfcatch>

</cftry>
<br>
<cftry>

<cfset tempValue=“”>
<cfset tempValue = XMLData(index,
“address.addressB”, “a”)>
<cfoutput>#tempValue# </cfoutput>
<cfcatch></cfcatch>

</cftry>
<br><br>

</cfloop>
<br>
</span>

Report/ID Generation Module

The report and ID generation module 170 is configured to assign the candidate a unique identification number and seal, and to assemble reports that include each of the search results provided by the respective display modules. The identification number and seal can be used on each of the reports generated for the candidate, and may also be used to access reports associated with the candidate. The reports generated can vary depending on the application. In one embodiment, the report and ID generation module 170 is configured to generate a summary report and a more detailed full report. Conventional graphical user interface techniques can be used to display a particular report. A hard copy of a report can be provided if so desired.

Access to each type of report can be restricted as desired. For example, a job seeker having a pre-screen seal associated with his online resume can opt to provide general access to his summary report, and restricted access to his full report. In addition, the full report generated by the module 170 can include one or more annotation sections that the job seeker can use to correct or otherwise comment on the information presented in the report. Example summary and full reports are shown in FIGS. 4b and 4c, respectively. To gain access to the summary report, a potential employer could, for example, click the seal on the job seeker's online resume, which would cause a window to open that displayed the summary report. The employer could then request access to the full report if so interested. Conventional windowing and hyperlinking techniques can be employed here in displaying the reports.

Local Database

As discussed above, the local database 60 can be partitioned or otherwise sectioned into relevant sections (e.g., criminal, civil, address, and identity database sections), and relevant portions of the user input can be used for each database search. The entire database may be contained, for example, in one server or in a number of a servers included in a server farm. Conventional database techniques can be employed here. The local database 60 is stocked with information retrieved from the Internet (e.g., via data crawler applications) and/or with information input locally via conventional data entry techniques.

The benefit of the local database is that the search and verification processes are simplified. This is because remote databases 70 need not be accessed to complete search and verification processes, thereby saving time and processing overhead. Note, however, that the present invention is not intended to be limited to using a local database that is pre-stocked with relevant information. Other configurations will be apparent in light of this disclosure.

For example, alternative embodiments of the present invention can operate by directly accessing via the Internet or other network infrastructure the various remote databases 70 during each requested search/verification. In one such embodiment, no local database 60 would be required. In another such embodiment, both remote databases 70 and local database 60 could be used. In such a case, the local database 60 could be, for example, limited to data entered locally (such as data which is not available over the Internet). It will be appreciated that such embodiments may not execute the verification process as fast as embodiments having a pre-stocked local database 60.

Aggregator with Data Crawlers

The data crawlers 150, 155, and 160 can be implemented in conventional technology, and are each configured to harvest data from one or more targeted remote databases 70. For example, each of the civil records data crawler 150 and the criminal records data crawler 155 can be programmed to access and harvest records from known online civil/criminal records databases of one or more states (e.g., many state and federal courts have public online databases that can be accessed for this purpose). Similarly, the address history data crawler 160 can access and harvest data from known online address databases (e.g., online white and yellow pages).

Each crawler can operate on a predetermined schedule (e.g., 1 a.m. to 4 a.m.) to improve efficiency and prevent interference with normal operations of the targeted databases. Each crawler can be configured with a local memory to temporarily store harvested data prior to its storage into the aggregated local database 60. Alternatively, each crawler module can be programmed so that the harvested data is stored directly into the appropriate section of the local database 60. In any case, the local database 60 is pre-stocked with information relevant to the verification process. Other targeted data crawlers may be included as well, such as a SS# data crawler module (to retrieve data for use in verifying an applicant's SS#) or a graduate/alumni data crawler module (to retrieve data for use in verifying an applicant's education).

Note that other embodiments of the candidate verification module 50 may be configured to perform additional and/or different searches and verifications, such as credit checks, organizational affiliations, and community standing checks (e.g., based on local news and general Internet search). Likewise, tailored or custom checks may be run as well, such as the type of vehicles that are registered under the applicant's name, and the real estate holdings recorded as being owned by the applicant. Numerous other such checks and verifications can be programmed or otherwise configured as will be appreciated in light of this disclosure. The type of searches and verifications performed will generally depend on the purpose of the verification.

For example, job seekers know that employers are looking for certain traits (e.g., honesty, reliability, education level, legal work status, and drug-free status). Thus, the background check for job seekers will likely include criminal and civil records searches, address history searches, social security number verification, education verification, and drug testing verification.

Similarly, a person using a dating service know that potential dates are looking for traits such as honesty, reliability, education level, good community standing, and material wealth. Thus, the background check for date seekers will likely include criminal and civil records searches, education verification, general news and Internet searches (e.g., online news paper archives and Google or Yahoo searches), type of car, and real estate holdings.

Similarly, owners of a startup business know that venture capital companies are looking for qualities such as financial responsibility, leadership skills, education, and relevant industry experience in the management team of the startup. Thus, the background check for such startup owners will likely include education verification, prior employment records annotated with independent peer review of each member on the management team of the startup, criminal and civil records searches (e.g., particularly records related to fraud, bankruptcy, tax issues, and liens), and general news (e.g., online news paper archives) and Internet searches.

Other example applications include underwriting services (e.g., pre-screened candidates having certain verified qualities may be entitled to lower premiums than non-pre-screened candidates), on-line chat rooms (e.g., pre-screened chat room members having a background verification seal indicating upstanding qualities may be more attractive to fellow chatters than those without a verification seal), and online auction sites (e.g., pre-screened sellers/buyers having a background verification seal indicating upstanding qualities may be more attractive to fellow buyers/sellers than those without a verification seal). Also, personnel involved in law enforcement, homeland defense, airport security, immigration, and other positions requiring a high degree of trustworthiness could be selected for employment based on a verification seal showing certain pre-screened qualities, such as excellent community standing, no criminal or civil issues, U.S. citizenship, and other traits showing strong loyalty to the U.S.

Note that each application of the pre-screen background check performed in accordance with the principles of the present invention may dictate the need for particular types of information. As such, the appropriate targeted data crawlers can be programmed or otherwise configured to harvest the relevant data for stocking the local database 60. Likewise, local data entry can be used to supply such data to the local database 60. Any relevant data that can be legally obtained can be stocked in database 60. Recall, however, that an aggregated local database 60 is not required for the present invention to operate (e.g., where the pre-screen service is carried out by directly accessing various local and/or remote databases).

Note that an alternative embodiment is implemented in a kiosk environment which allows candidates to access the system “on-site” (as opposed to online). In such an embodiment, the applicant might be attending, for example, a career fair at a convention center or a brick-and-mortar dating service location. Once on-site, the candidate can use the kiosk or other similar type work station to access the background verification system to get pre-screened as described herein. The system may be fully contained in the kiosk, wherein database 60 is within the kiosk and updated offline as part of a periodic maintenance (e.g., performed daily or prior to deployment at the particular site). In such an embodiment, note that the data crawlers 150-160, the input module 165, and Internet connection 30 would not necessarily be included in the kiosk. Alternatively, the kiosk can be coupled to the Internet 30, and simply provide a user interface and online connection to a remote background verification system. Other such variations will be apparent in light of this disclosure. In any such cases, the candidate can be pre-screened on-site in accordance with the principles of the present invention. The kiosk could be further configured to provide the pre-screened candidate a “pre-screen seal” or other marker that could be used by the candidate during the on-site event.

Methodology

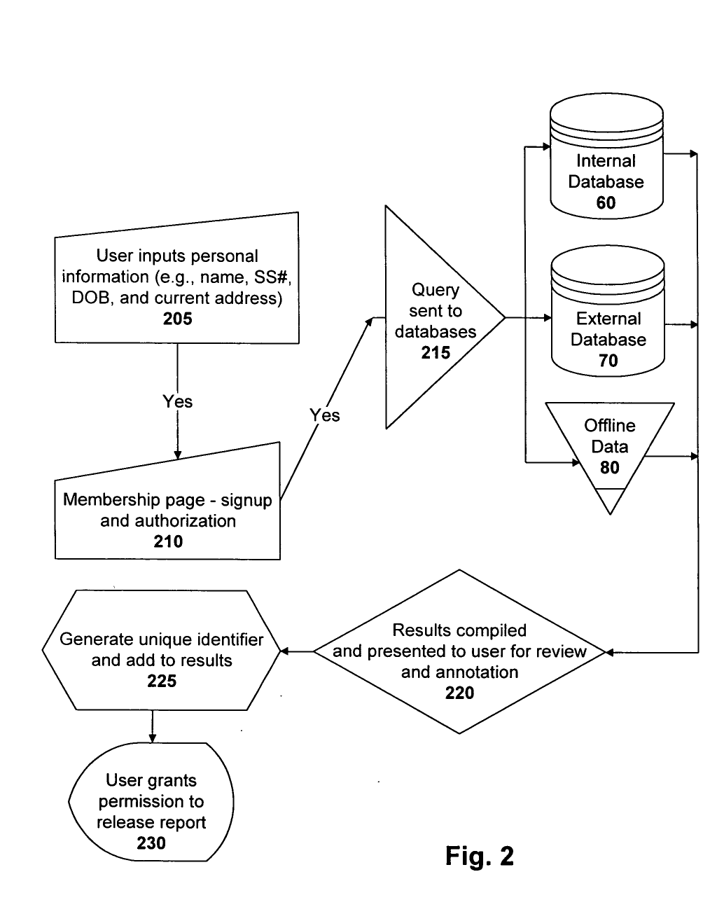

FIG. 2 illustrates a method in accordance with one embodiment of the present invention. The method allows an applicant to pre-screen himself as having certain qualities by obtaining his own background check. In a more general sense, any background data that may be relevant to a particular applicant can be checked and/or confirmed as accurate. The results of the background data verification can then be associated with the applicant's resume, application, or advertising using a seal or other marker. The seal is in turn recognized by various parties that might be interested in engaging the applicant.

The seal may expressly indicate on its face the particular qualities (e.g., “No criminal or civil records” and “SS# verified” or “High Standing in Community”). Alternatively, the mere presence of the seal or marker can be understood to mean that various pre-defined criteria specified by an engaging party (e.g., employer) have been met or exceeded by the applicant associated with the seal. In any event, the engaging party can more efficiently ascertain whether an applicant or other candidate should be considered for a position or other type of engagement.

An applicant or other user of the method can use a computer to log onto a network (e.g., Internet or LAN) to establish a connection with the system that carries out the method. The connection process can be securely implemented with conventional techniques. Alternatively, the applicant can call into customer service (not shown) to have a background verification performed. Alternatively, the applicant can access the system “on-site” by way of a user-friendly kiosk. The method can be employed by any service provider, such as online job posting merchant, a human resource agency, a corporation or small business venture, or a security firm. There can be a subscription fee or a user fee applicable.

The method begins with the user inputting 205 or otherwise providing his personal information, such as first, middle, and last name, social security number, date of birth, and current address. As previously stated, the user can be, for example, a job seeker, a person looking for a date through the workings of a dating service, a small business seeking a positive report so as to be more attractive to venture capital firms, or a tradesman looking to attract customers. Other user data can be requested as well, depending on the particular application and the type of verification being conducted. Upon providing the personal information, the user is presented with a membership page or otherwise guided through the membership process by a customer service representative of the pre-screening service.

Here, the method continues with the user signing up for the pre-screening service, and authorizing 210 the background check to be performed (assuming the user has not already signed-up and provided authorization). In one particular embodiment, the method here includes having the user input credit card information to pay for the service. The fee for membership can be charged, for example, via a security and payment e-commerce site (e.g., VeriSign). If the individual chooses a payment method, he will need to supply all pertinent information as required for authentication and validation of the Internet e-commerce web site.

Upon receiving the user's authorization, the method continues with querying 215 one or more databases that can be accessed to search for information relative to pre-screening the user. As previously explained, the databases accessed may be local (e.g., stocked via operation of an aggregator system of targeted data crawlers), remote (e.g., each database stocked independently at various locations), or a combination of local and remote databases.

The query may initiate a number of checks using part or all of the user's personal information. In one embodiment, the checks performed include attempting to verify the user's social security number (e.g., by matching and crosschecking the entered name and SS# with a database of known names and SS#s), identify previous addresses (e.g., by searching a database stocked with publicly available historical address information for addresses associated with the user's name), and find any existing civil and/or criminal records (e.g., by searching a database stocked with civil and criminal records of one or more states for any records associated with the user's name and SS#). As will be apparent in light of this disclosure, numerous other types of information that can be legally accessed can be searched to perform one or more specific types of verifications and/or background checks as part of the query.

In one particular embodiment, the database is local to facilitate rapid query-based searching. Here, the database would include an aggregation or collection of historical and/or public records, and have multiple database subsets, files and records gathered from numerous sources. The multiple sources can have multiple addresses, and range from the current year to the prior forty years, for example. The database can be structured and organized using conventional techniques to further facilitate rapid searching. Each data subset can be contained within a data field of a database, and the method can further comprise the step of presenting a list of the subset lookup results for review, wherein the list of the subset lookup is selected from the result query, and wherein the data subset can be installed and linked against other data.

Upon completion of the database query, the method continues with compiling 220 the results of the query, and presenting those results to the user for review and annotation (if so desired). Thus, the user can add input or otherwise annotate the report to provide any additional information that may be helpful to the reviewing party. Such annotation allows for the disputing and documenting of erroneous data. The method continues with generating 225 a unique identifier that will be used for a reference to gain viewable access to the user's resulting background check report. This unique identifier is merged or otherwise associated with the report. The unique identifier can be, for example, a URL address that corresponds to the secure location of the report. Alternatively, the unique identifier can be an secure access code that must be entered to gain access to the report.

As previously explained, the uniquely identifiable report can be used as a validation source for many applications such as employment, underwriting, dating, and other situations where one party wishes to engage another party that has various desired qualities (e.g., upstanding and highly regarded in community, trustworthiness, and U.S. citizen). The method continues with the user granting 230 permission to release the report to various requesting interested parties. The user may grant permission either based on a whole (e.g., everyone can view the background report) or based on an individual (e.g., each request from a potential employer is considered separately). Recall that a potential employer (or other interested party) knows that such a report is available based on the seal or other mark associated with the user.

Note that additional functionality may be included in the method. For instance, the method may further include a manual selection, wherein an offline search can be conducted to verify that the individual has no criminal or civil record for states which they have lived, where those states do not have a central repository that is available via an external Internet connection.

Integration of Pre-screening into Online Service

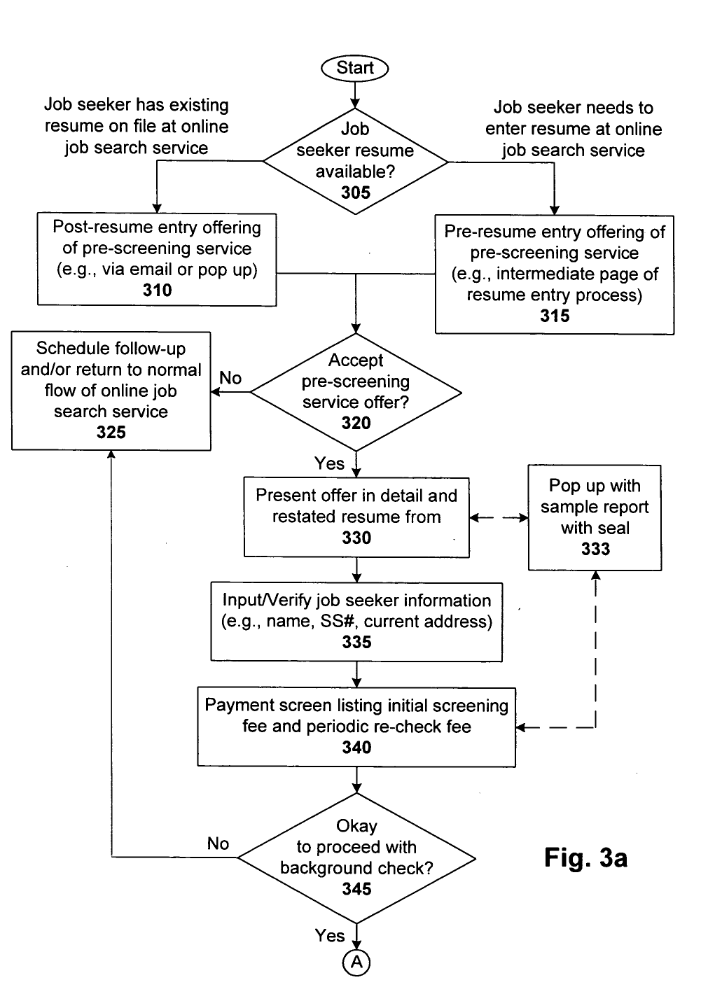

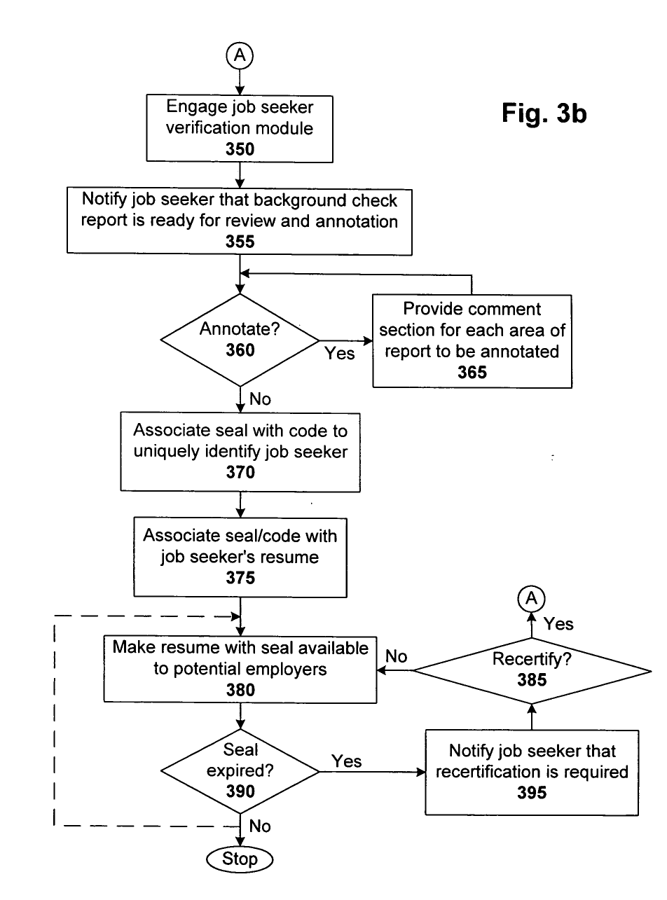

FIGS. 3a and 3b illustrate a method for use in conjunction with an online job search service that allows a job seeker to pre-screen their own background to distinguish themselves from other non-pre-screened job seekers in accordance with one embodiment of the present invention. It will be apparent in light of this disclosure, however, that other online services (e.g., online dating services) could also benefit from the methods described herein.

In this particular example, the method begins with determining 305 whether the job seeker has a resume already on file with the job search service. If the job seeker has an existing resume on file at the online service, then the method includes offering 310 a pre-screen service. Such a post-resume entry offering can be carried out, for example, via an email to the job seeker from the job search service, or a pop-up window that manifests when the job seeker logs into the job search service. Similarly, if the job seeker does not have an existing resume on file at the online service, and needs to enter his resume, then the method includes offering 315 the pre-screen service. Such a pre-resume entry offering can be carried out, for example, via an intermediate page that manifests during the resume entry process.

In either case, the method includes determining 320 whether the pre-screen service offer was accepted. If the pre-screen offer is not accepted, then the method may continue with scheduling 325 a follow-up and/or returning to the normal flow of the online job search service. The follow-up could include scheduling an email or other communication to be sent to the job seeker in one month or so to re-offer the pre-screen service.

If the pre-screen offer is accepted, then the method continues with presenting 330 the pre-screen offer in detail, as well as presenting an job seeker's online resume in a form that will be seen by the various viewers, including a “pre-screen seal” that indicates that the job seeker has various qualities desirable to employers. The method may further include providing 333 a pop-up with a sample background report that is associated with the seal. At this point, the job seeker may be asked to advance the process by selecting “continue” and/or closing any pop-ups. Various user interface techniques can be used here to ease the process and presentation of information.

The method proceeds with the job seeker inputting 335 information required to carry out the background check. In one embodiment, the input information includes the job seeker's name, social security number, date of birth, and current address. Other information could be input here as well, depending on the desired pre-screen background check. After the information is input, the user can be given the opportunity to review, edit and/or verify as necessary.

The method continues with displaying 340 the payment screen, which lists the initial screening fee. The payment screen may also list the periodic re-check fee to keep the job seeker's background report up to date. Here, the job seeker can be given the opportunity to cancel the pre-screen process or to proceed, at which point the job seeker would be charged for the service. Note that the method may further include providing 333 a pop-up with a sample background report that is associated with the seal to further entice the job seeker to continue.

The method therefore continues with determining 345 if the job seeker wishes to proceed with the background check. If no, then the method of this particular embodiment continues with scheduling 325 a follow-up and/or returning to the normal flow of the online job search service as previously explained. If, however, the job seeker wishes to proceed with the background check, then the method continues with engaging 350 the verification module 50. As previously discussed, the verification module 50 will conduct a number of background checks and verifications, and then assemble the results into a viewable report.

The method continues with notifying 355 the job seeker that the background check report if ready for review and annotation. At this point, the method proceeds with determining 360 whether the job seeker wishes to annotate the report. If yes, then the method continues with providing 365 a comment section for each area of the report to be annotated. Thus, the job seeker can select a section of the report to annotate, annotate that section as desired, and then proceed to the next section that the job seeker wishes to annotate, and so on.

When no further annotation is desired, the method continues with associating 370 a seal with code to uniquely identify the job seeker. The seal itself represents to various viewers that the job seeker has been pre-screened. The associated code will allow access to the report associated with that seal. The method further includes associating 375 the seal/code with the job seeker's resume or application. The method proceeds with making 380 the resume with the seal available to potential employers. The potential employers can then choose to select that resume, and access the report (if the job seeker has approved such access).

The method may further include determining 390 if the seal associated with the resume has expired. This determination can be made periodically (e.g., once per month). If the seal is not expired, then the method can be configured to repeat steps 380 and 390. If, however, the seal is expired, then the method may proceed with notifying 395 that recertification is required. At this point, the method includes determining 385 whether the job seeker wishes to recertify.

If no, then the method can be configured to repeat steps 380 and 390. In such a case, an potential employer may eventually notice that the report has expired and request an update, thereby giving the job seeker a second opportunity to get recertified. Alternatively, the job seeker can simply terminate the process for what ever reason (e.g., job seeker found a job and is no longer looking). If the job seeker wishes to recertify, then the method continues with repeating steps 350 to 395. Note that the job seeker can be charged a recertification fee at that time.

FIG. 4a illustrates an example graphical user interface for initiating job seeker verification in accordance with one embodiment of the present invention. As can be seen, the job seeker is provided one section of the interface, and potential and interested employers are provided another section of the interface. The job seeker section of the interface allows the job seeker to input the personal information needed to carry out the background check and verification process. The potential employer section of the interface allows interested employers to enter the unique code associated with a particular pre-screened application so that the background report of that applicant can be viewed. Note that the code can be, for example, an alphanumeric code or a URL that is associated with the particular applicant. The functionality underlying the interface, and as explained herein is then executed when the user selects “Go.”

FIG. 4b is a graphical user interface displaying results to an employer's query to a database of job seekers, some of whom are pre-screened in accordance with one embodiment of the present invention. The interface may be included, for example, in an online job search service, and provides potential employers a second way to access a particular candidate's report (the first way is entering a candidate's access code as discussed in reference to FIG. 4a).

Here, the employer has queried the resume database on the online job search service in effort to identify potential candidates for a particular position the employer is seeking to fill. The query of the database can be carried out using conventional database query techniques, and might specify, for example, the type of degree and years of experience desired. The results of the query are then presented to the employer as is usually done.

However, note that two of the twenty-five potential candidates identified by the query are associated with a pre-screen seal, thereby indicating that these two applicants have pre-screened themselves (e.g., sanctioned a background check and verification of certain information). As such, the viewing employer may be inclined to select one of those two candidates over the other non-pre-screened candidates. For instance, to investigate further, the employer can click or otherwise select candidate fifteen. In response to this selection, the employer is presented with a window or page that displays that candidate's resume, as well as the pre-screen seal. The employer can then click the pre-screen seal to gain access to that applicant's summary pre-screen or background report, as discussed in reference to FIG. 4c.

FIG. 4c illustrates a graphical user interface for showing a summary of a verification report, as well as underlying functionality that interface, in accordance with one embodiment of the present invention. As can be seen, the report is presented in summary form, and gives the viewer basic information about the candidate and his associated background check, including the candidate's name, report number, and the type of checks performed. Note that the viewer may be the candidate or a potentially interested party.

In this particular example, the checks performed include social security number verification, address history verification, recorded civil actions, and recorded criminal activity. A help link (“?”) can be provided next to explain the nature and scope of each check performed. Here, the results indicated on the summary report are favorable to the candidate, in that the SS# and address history provided by the candidate were verified as accurate when checked against databased information. Also, no criminal or civil records were found.

Note that if so desired, the user interface allows the viewer to order more reports (additional checks and verifications) for the candidate. The additional reports might include, for example, education verification and community standing, or civil and criminal record checks for other states. As can be seen, if the viewer selects more reports to be ordered, the underlying methodology includes emailing 550 the candidate to request approval for more reports to be run.

If the candidate approves, then the method includes emailing 545 a release code (or other form of approval) back to the requesting party. The requesting party/candidate combination may be, for example, a potential employer/employee, a potential date/suitor, or potential customer/tradesman. The requesting party can then use the release code to sanction additional reports. Fees may be charged to the requesting party at this time. If the candidate does not approve additional reports, then the method includes emailing 540 the requesting party a request to contact the candidate directly to discuss the need for additional reports.

The user interface also allows the viewer to review the candidate's full report. Here, the underlying methodology includes emailing 530 the candidate to request release of the full report. If the candidate approves release, then the method includes emailing 545 a release code (or other form of approval) back to the requesting party. The requesting party can then use the release code to access the full report (e.g., via entering the code at the user interface page shown in FIG. 4a). If the candidate does not approve release of the full report, then the method includes emailing 540 the requesting party a request to contact the candidate directly to discuss access of the full report. Variations on this underlying methodology will be apparent in light of this disclosure. For instance, emailing may be replaced by phone calls or other forms of communication. Also note that advance approval can be given by the candidate, thereby eliminating the need for requesting approval by interested parties.

FIG. 4d illustrates a graphical user interface for showing a full verification report, as well as underlying functionality that interface, in accordance with one embodiment of the present invention. Here, the report includes additional information associated with each check performed. For instance, the identified address history is listed, and a civil action record is indicated (e.g., small claims action filed against the candidate; no liability was found). Just as with the summary report, the viewer of the full report is given the opportunity to order additional reports to be run. The underlying methodology is as previously discussed.

Also included on the user interface of the full report are “Details & Comments” buttons that can be selected. These buttons provide links to details associated with a particular report section and any annotation or comments provided by the applicant. In the example shown, the viewer has clicked the “Details & Comments” button associated with the candidate's Civil Record. In response, a new window opens to display details of the reported small claims action, as well as the candidate's comments regarding the action. Such annotation may provide the viewer better insight into a candidate's suitability for engagement.

Various other situations where annotation by a candidate might be appropriate will be apparent here. For example, the report may show 125 Main Street, Boston, Mass. as a previous address; however, the candidate never lived at that address. The annotation section would allow a response to this and would be viewable to anyone that has been granted permission to see.

The foregoing description of the embodiments of the invention has been presented for the purposes of illustration and description. It is not intended to be exhaustive or to limit the invention to the precise form disclosed. Many modifications and variations are possible in light of this disclosure.

For example, note that the “pre-screen seal” can be issued by any one entity (e.g., an online job search service) and associated with the candidate's resume where ever it is submitted. Thus, paper copies of the candidate's resume can have the pre-screen seal and access code printed thereon, just as electronic copies of the resume submitted at other online job search services can be associated with an image of the pre-screen seal and access code. In such cases, the pre-screen seal and access code are known to be associated with the pre-screen online service which can be accessed using the access code. Thus, the employers need only take the access code, and go to that pre-screen online service to access background and verification reports associated with that applicant. In this sense, embodiments of the present invention encourage brand recognition by virtue of the “pre-screen seal.”

It is intended that the scope of the invention be limited not by this detailed description, but rather by the claims appended hereto.

1. A system for performing a candidate-initiated background check and verification, the system comprising:
a search module adapted to issue a candidate-initiated query to one or more databases storing information associated with various potential candidates, so as to assess the candidate's acceptability for a particular engagement based on at least one of a background check and verification of information provided by the candidate; and
a report generation module configured to generate a report that includes query results provided by the search module, the results indicating the candidate's acceptability for the particular engagement, wherein the report can be selectively viewed by a potential engaging party and further includes at least one section where the candidate can annotate the results.

2. The system of claim 1 wherein the candidate is a job seeker, the potential engaging party is a potential employer having a pre-defined set of criteria for persons the employer is willing to hire, and the particular engagement is employment with the employer.

3. The system of claim 1 wherein the candidate is a date seeker that is using a dating service, the potential engaging party is a person having a pre-defined set of criteria for date seekers that person is willing to date, and the particular engagement is a date with that person.

4. The system of claim 1 wherein the candidate-initiated background check and verification is performed online, and the candidate accesses the system via the Internet to initiate the issuing of the query.

5. The system of claim 4 wherein the candidate-initiated background check and verification is performed in the context of an online job search service or an online dating service.

6. The system of claim 1 further comprising the one or more databases storing information associated with various potential candidates, wherein the one or more databases are local to the system, thereby enabling rapid query-based searching.

7. The system of claim 6 wherein the one or more local databases are stocked at least in part by data crawler applications that search targeted remote databases.

8. The system of claim 1 further comprising the one or more databases storing information associated with various potential candidates, wherein the one or more databases are remote to the system.

9. The system of claim 1 further comprising:
a candidate data intake module configured to prompt the candidate to provide personal information needed to execute the query, the personal information including at least one of the candidate's name, social security number, date of birth, and current address.

10. The system of claim 1 wherein the search module includes at least one of an address history search module for searching for the candidate's address history, a civil record search module for searching for civil action records associated with the candidate, a criminal record search module for searching for criminal records associated with the candidate, and a social security verification module for verifying the candidate's social security number.

11. The system of claim 10 wherein the search module further includes one or more display modules, each configured to enable display of at least a portion of the results included in the report.

12. The system of claim 1 wherein the report generation module is further configured to assign the candidate a unique identification number and seal that are associated with the candidate, where the seal indicates that the report is available, and the unique identification number allows the potential engaging party to access the report.

13. The system of claim 1 wherein the report is associated with an expiration date.

14. A system for performing a candidate-initiated background check and verification, the system comprising:
a local database stocked with information relevant to various potential candidates, wherein the information enables at least one of background checks and verification to be performed so as to pre-screen a candidate's acceptability for a particular engagement;
one or more search modules communicatively coupled with the database, each search module configured to issue a candidate-initiated query to the database to assess the candidate's acceptability for the particular engagement;
a report generation module configured to generate a report that includes query results provided by the one or more search modules, the results indicating the candidate's acceptability for the particular engagement, and the report is associated with a unique identification number that allows the potential engaging party to access the report.

15. The system of claim 14 wherein the report generation module is further configured to associate the report with a seal that is placed on at least one of the candidate's resume, application, online dating service file, or advertising, and the seal indicates to the potential engaging party that the report is available.

16. The system of claim 14 wherein the report is associated with an expiration date.

17. A method for performing a candidate-initiated background check and verification, the method comprising:
issuing a candidate-initiated query to one or more databases storing information associated with various potential candidates, so as to assess the candidate's acceptability for a particular engagement based on at least one of a background check and verification of information provided by the candidate;
generating a report that includes results of the candidate-initiated query, the results indicating the candidate's acceptability for the particular engagement; and
allowing the candidate to review and annotate the report prior to any selective viewing by a potential engaging party.

18. The method of claim 17 wherein the candidate is a job seeker, the potential engaging party is a potential employer having a pre-defined set of criteria for persons the employer is willing to hire, and the particular engagement is employment with the employer.

19. The method of claim 17 wherein the candidate is a date seeker that is using a dating service, the potential engaging party is a person having a pre-defined set of criteria for date seekers that person is willing to date, and the particular engagement is a date with that person.

20. The method of claim 17 wherein the candidate-initiated background check and verification is performed online, and issuing the candidate-initiated query is triggered in response to the candidate providing input via the Internet.

21. The method of claim 17 wherein the candidate-initiated background check and verification is performed in the context of an online job search service or an online dating service.

22. The method of claim 17 further comprising storing the information associated with various potential candidates in one or more local databases, thereby enabling rapid query-based searching.

23. The method of claim 22 further comprising stocking the one or more local databases at least in part using data crawler applications that search targeted remote databases.

24. The method of claim 17 wherein issuing the candidate-initiated query to one or more databases includes accessing one or more remote databases.

25. The method of claim 17 further comprising prompting the candidate to provide personal information needed to execute the query, the personal information including at least one of the candidate's name, social security number, date of birth, and current address.

26. The method of claim 17 wherein issuing the candidate-initiated query to one or more databases further includes at least one of searching for the candidate's address history, searching for civil action records associated with the candidate, searching for criminal records associated with the candidate, and verifying the candidate's social security number.

27. The method of claim 17 further comprising assigning the candidate a unique identification number that allows the potential engaging party to access the report.

28. The method of claim 17 further comprising associating the report with an expiration date.

29. The method of claim 17 further comprising associating the report with a seal that is placed on at least one of the candidate's resume, application, online dating service file, or advertising, wherein the seal indicates to the potential engaging party that the report is available.

30. The method of claim 17 further comprising allowing the potential engaging party to review the report in response to the candidate releasing the report for review.

31. The method of claim 17 further comprising allowing the potential engaging party to sanction additional reports relevant to the candidate in response to the candidate's approval.

32. The method of claim 17 further comprising notifying the candidate that the report has expired if an expiration date associated with report has passed.

33. The method of claim 32 further comprising recertifying the report in response to the candidate affirmatively responding to the notifying.

34. The method of claim 17 further comprising periodically recertifying the report to prevent engagement based on stale data.

35. The method of claim 17 further comprising allowing the potential engaging party to recertify the report in response to approval by the candidate.

36. The method of claim 17 wherein the candidate-initiated background check and verification is performed on-site using a kiosk.

37. A computer readable medium encoded with software, that when executed by a processor, causes the processor to carry out a process for performing a candidate-initiated background check and verification, the process comprising:
issuing a candidate-initiated query to one or more databases storing information associated with various potential candidates, so as to assess the candidate's acceptability for a particular engagement based on at least one of a background check and verification of information provided by the candidate;
generating a report that includes results of the candidate-initiated query, the results indicating the candidate's acceptability for the particular engagement; and
allowing the candidate to review and annotate the report prior to any selective viewing by a potential engaging party.
